(19) United States
(12) Patent Application Publication
(10) Pub. No.: US 2005/0000083 A1
(43) Pub. Date: Jan. 6, 2005

(54) Method of attaching a rotor to a shaft

(75) Inventors: Jerry D. Edwards, Bristol, VA (US); John W. Tolbert, Bristol, TN (US); David T. Monk, Bristol, VA (US); Richard L. Smith, Kingsport, TN (US)

Correspondence Address: MCNEES, WALLACE & NURICK LLC, 100 PINE STREET, P.O. BOX 1166, HARRISBURG, PA, 17108-1166, US

(73) Assignee: Bristol Compressors, Bristol, VA (US)

(21) Appl. No.: 10/440,756

(22) Filed: May 19, 2003

(51) Int. Cl. H02K 5/16

(52) U.S. Cl. 29/596; 29/888.021; 310/90; 29/888.022

(57) ABSTRACT

A method of attaching a rotor to a shaft is provided to obtain increased motor performance. The increased motor performance is obtained as a result of a high impedance gap that is formed between the rotor bars and the rotor core during the heat shrinking operation to attach the rotor to a shaft. In the heat shrinking operation, the rotor is heated to between 600-800° F. At this temperature the aluminum in the rotor bars expands faster than the steel in the rotor core and causes a deforming or yielding of one or both of the materials. As a result of this deformation of the material, the cooling of the rotor results in the formation of a gap between the rotor bars and the rotor core that operates as a high impedance barrier between the rotor bars and rotor core.

### BACKGROUND OF THE INVENTION

The present invention relates generally to a method of attaching a rotor of a compressor motor to a shaft of a compressor. More specifically, the present invention relates to a method of attaching a rotor of a compressor motor to a crankshaft of the compressor that results in greater compressor motor performance.

A squirrel cage rotor for use in an induction motor has a rotor core and a rotor cage that extends through the rotor core and is connected together at each end of the rotor core by end rings. The rotor core is typically made of a magnetic material such as iron or steel and the rotor cage is typically made of an electrically conductive material such as copper, aluminum or an aluminum alloy. The rotor core has a substantially cylindrical shape with a longitudinally extending central bore to receive the shaft of the motor and a plurality of longitudinally extending rotor slots or apertures positioned equidistantly about the central bore, which rotor slots may be slightly skewed, to receive corresponding rotor bars of the rotor cage. A laminated rotor core is commonly manufactured or formed by stacking or assembling a plurality of discs or laminations of the magnetic material on top of each other until the desired substantially cylindrical shape is obtained. During the stacking or assembling process, the laminations are also aligned or oriented into their proper position. Alternatively, the rotor core can be manufactured from a single piece of the magnetic material, but this technique is less common.

Next, the rotor cage is manufactured or formed by positioning or disposing a rotor bar into each of the plurality of rotor slots in the rotor core, which rotor bars extend to at least the ends of the rotor slots, and connecting the adjacent ends of the rotor bars to each other with an end ring. In one technique, the stacked laminations forming the rotor core can be welded together and/or axially compressed to fix their position and can then be placed in a mold. Once in the mold, the rotor bars, and possibly the rings, can then be formed by die casting or injection molding molten aluminum (or other suitable material), under high pressure, directly into the rotor slots and possibly into molds for the end rings.

After the rotor cage has been cast, injected or introduced in the rotor core, the rotor is then cooled. After the rotor is cooled, a heat shocking treatment, also known as “bluing” can be applied to the rotor. In this heat shocking treatment, the rotor is heated in an oven to about 800° F. for about an hour. During this heat shocking treatment, the aluminum of the rotor cage expands faster than the steel of the rotor core. The unequal expansion rates of the aluminum and the steel result in one or both of the rotor cage and rotor core being deformed. Upon cooling the rotor after the heat shocking treatment, a high impedance gap between the rotor bars and the rotor core is formed that improves the performance of the motor.

When the rotor is ready for attachment to the crankshaft or shaft of the compressor, the rotor is heated a second time to about 450° F. in a heat shrinking or shrink-fitting operation. This heating of the rotor expands the center bore of the rotor a sufficient amount to receive the crankshaft. After the crankshaft is inserted into the center bore, the rotor is cooled to contract around the crankshaft forming a tight interference fit between the rotor and the crankshaft.

One potential problem with the above method of rotor manufacturing and attachment to the crankshaft is that it is very costly and time consuming to achieve the improved motor performance. The heating of the rotor in the heat shocking treatment is a time consuming step that adds to the cost of the rotor. In addition, the rotor is reheated when it is attached to the crankshaft. To lower the cost of the rotor, the heat shocking treatment can be omitted, however this is at the expense of motor performance.

Therefore, what is needed are more efficient and cost-effective techniques for attaching the rotor to the crankshaft of the compressor that result in a high impedance gap between the rotor bars and the rotor core to provide improved motor performance.

### SUMMARY OF THE INVENTION

One embodiment of the present invention is directed to a method of attaching a rotor of a compressor motor to a crankshaft of a compressor. The method includes providing a laminated rotor for a compressor motor. The laminated rotor has a central bore and includes a rotor core and a plurality of rotor bars cast into the rotor core. The method also includes providing a crankshaft for a compressor. The crankshaft has an outer diameter greater than an inner diameter of the central bore of the laminated rotor. Next, the laminated rotor is heated to a temperature of about 600-800° F. to expand the central bore of the laminated rotor to a diameter sufficient to receive the crankshaft. The laminated rotor is then positioned on the crankshaft. Finally, the laminated rotor is cooled such that the rotor core contracts about the crankshaft to connect the laminated rotor to the crankshaft and a high impedance gap is generated between the rotor bars and the rotor core to reduce rotor current losses in a compressor motor.

Another embodiment of the present invention is directed to a method of attaching a laminated rotor to a shaft. The method includes providing a laminated rotor having a central bore. The laminated rotor has a rotor core and a rotor cage having a plurality of rotor bars cast into the rotor core. A shaft is provided having an outer diameter greater than an inner diameter of the central bore of the laminated rotor. Next, the laminated rotor is heated to a temperature of about 600-800° F. to expand the central bore of the laminated rotor to a diameter sufficient to receive the crankshaft and the laminated rotor is placed onto the shaft. Finally, the laminated rotor is cooled. The cooling of the laminated rotor contracts the rotor core about the shaft to connect the laminated rotor to the shaft and generates a high impedance gap between the plurality of rotor bars and the rotor core to reduce rotor current losses in a motor incorporating the rotor.

One advantage of the present invention is a more efficient assembly process for the rotor and crankshaft.

Another advantage of the present invention is that current losses in the rotor core during operation of the motor are reduced providing increased motor performance.

Yet another advantage of the present invention is that improved motor performance can be obtained without incurring substantial additional cost.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of a laminated rotor core for use with the present invention.

FIG. 2 illustrates a top view of a lamination from the laminated rotor core of FIG. 1.

FIG. 3 illustrates a perspective view of a rotor from an embodiment of the present invention.

FIG. 4 illustrates a cross-sectional view of the rotor of FIG. 3 taken along line IV-IV of FIG. 3.

FIG. 5 illustrates a perspective view of a rotor attached to a shaft from an embodiment of the present invention.

FIG. 6 illustrates a cross-sectional view of the rotor and shaft of FIG. 5 taken along line VI-VI of FIG. 5.

Wherever possible, the same reference numbers will be used throughout the drawings to refer to the same or like parts.

### DETAILED DESCRIPTION OF THE INVENTION

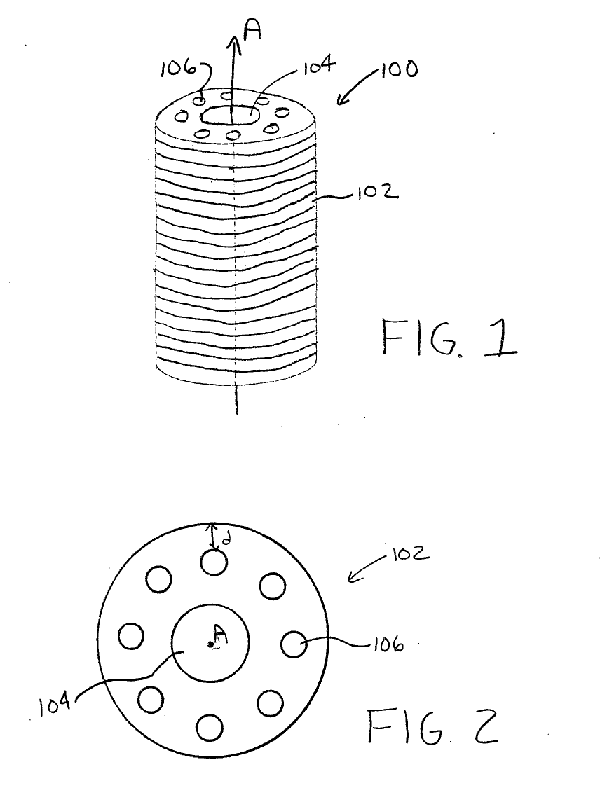

FIG. 1 illustrates a laminated rotor core 100 for use with the present invention. The laminated rotor core 100 is preferably used in a squirrel cage rotor of an induction motor for a compressor. The laminated rotor core 100 is formed or assembled by stacking a plurality of laminations 102. The number of laminations required to assemble the laminated rotor core 100 is dependent upon the thickness of the laminations 102 and the desired height of the laminated rotor core 100. In one embodiment of the present invention, the thickness of the laminations can range from about 0.015 inches to about 0.025 inches and is preferably 0.022 inches thick for a standard application and 0.018 inches thick for a “low loss” application.

FIG. 2 illustrates a top view of a lamination 102. Each lamination 102 that is assembled into the laminated rotor core 100 preferably has a central aperture or bore 104. The central bore 104 of the laminated rotor core 100 is configured to receive a shaft of the motor as will be described in greater detail below. In addition, each lamination 102 preferably has a plurality of rotor slots or apertures 106. The rotor slots 106 are closed to the outer circumference of the laminated rotor core, i.e., they are closed rotor slots. It is to be understood that apertures 106, while being referred to as rotor slots and shown as circular apertures in the Figures can have any desired shape including oval, circular, rectangular, irregular or any other suitable shape. The plurality of rotor slots 106 are positioned circumferentially about the center axis A of the lamination 102. The plurality of rotor slots 106 are positioned equidistant and/or equiangular to one another about the axis A. The shape, number and size of the rotor slots 106 are dependent on the particular configuration of the motor and rotor cage used. In addition, the size of the rotor bars is related to the number of rotor bars. As the number of rotor bars increases the corresponding size of the rotor bars decreases and as the number of rotor bars decreases the size of the rotor bars can increase. In one embodiment of the present invention, the number of rotor slots (and bars) can range from about 20 to about 40 and is preferably 34 bars for a high torque application and 28 bars for a high performance application.

Furthermore, each rotor slot 106 is positioned a distance “d” from the outer circumference of the lamination 102. The distance “d” corresponds directly to the bridge thickness of the lamination 102 and laminated rotor core 100. To obtain optimal motor performance, the bridge thickness “d” should be as small or thin as possible while still maintaining the structural integrity of the rotor during operation of the motor. For example, for a laminated rotor core 100 having an outer diameter of 2.6 inches, the bridge thickness is preferably between 0.01 inches and 0.02 inches wide. The preferred bridge thickness “d” can vary depending on the configuration and size of the motor. Finally, it is to be understood that the lamination 102 can include additional features which are not shown for simplicity.

The laminations 102 are preferably formed from a magnetic material such as iron or steel by an extrusion or pressing operation of one or more steps. After the laminations 102 are extruded or formed, they are stacked or assembled to obtain the laminated rotor core 100. During the assembly operation, the laminations 102 are preferably aligned and/or oriented to obtain a central bore 104 which extends substantially longitudinally and coaxially through the laminated rotor core 100 and to obtain rotor slots 106 which extend substantially longitudinal and coaxially through the laminated rotor core 100, i.e., the rotor slots 106 have a skew of 0 degrees. In another preferred embodiment, the laminations 102 can be oriented to obtain rotor slots 106 that extend longitudinally through the laminated rotor core 100 with a skew of 2-15 degrees and preferably between about 4-12 degrees. The embodiment of the laminated rotor core 100 that does not have a skew of the rotor slots 106 can be used for a three phase application and the embodiment of the laminated rotor core 100 that has a skew of the rotor slots 106 can be used for a single phase application.

The assembled and aligned laminated rotor core 100 is placed in a mold of a casting or injection molding apparatus (not shown). Once the laminated rotor core 100 is placed in the mold, compressive pressures and forces, as known in the art, are applied to the laminated rotor core 100 by the mold and/or casting or injection molding apparatus to hold or secure the laminated rotor core 100 in position for the casting or injection molding operation. Upon being secured in the mold of the casting or injection molding apparatus, the laminated rotor core 100 is now ready for the commencement of the casting or injection molding operation to manufacture some or all of the rotor cage. The casting or injection molding apparatus includes a system or device for casting, injecting or introducing a molten material, preferably aluminum or aluminum alloy, into the rotor slots 106 of the laminated rotor core 100 to form the rotor bars and for preferably casting, injecting or introducing the molten material into a mold or cast at each end of the rotor core 100 to form the end rings that connect or short circuit the ends of the rotor bars. It is to be understood that any suitable type of casting or injection molding apparatus and/or mold can be used for the casting or injection molding of the rotor cage. Finally, while not described herein, the remaining process steps for the manufacture of the rotor would be substantially completed as is well known in the art.

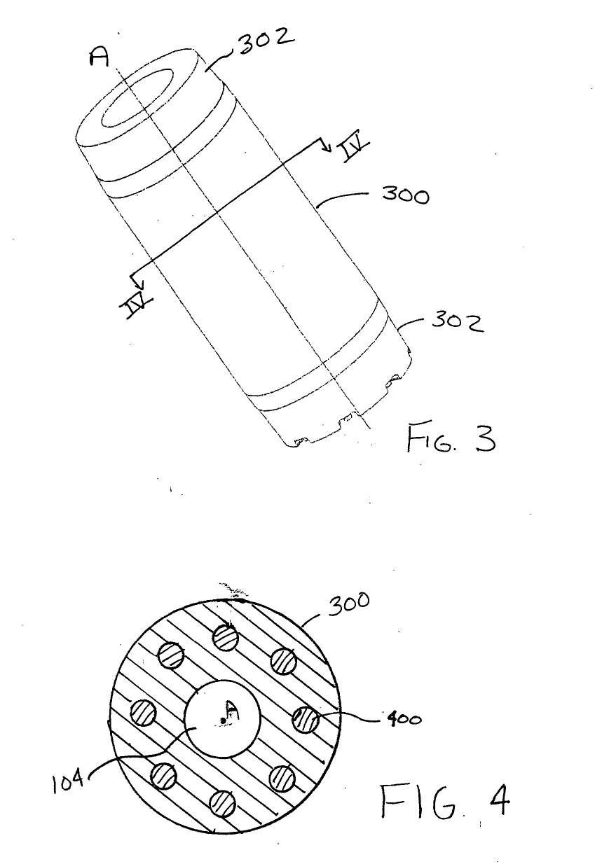

FIG. 3 illustrates a rotor 300 after the casting or injection molding operation has been completed and the rotor 300 has had an opportunity to cool. End rings 302 connect the rotor bars 400 (see FIG. 4) that have been cast into the rotor core 100. As can be seen in FIG. 4, the rotor bars 400 have substantially filled the rotor slots 106 and may be in contact with or have a very close proximity to the steel laminations 102 of the rotor core 100. This possible contact or very close proximity between the rotor bars 400 and the rotor core 100 can be a source of possible current losses in the rotor 300 during operation, thereby reducing the performance of the motor. To overcome this possible source of current loss in the rotor 300, the present invention applies a heat shocking treatment to the rotor 300 when the rotor 300 is heated for the shrink-fitting or heat shrinking of the rotor 300 to a shaft or crankshaft.

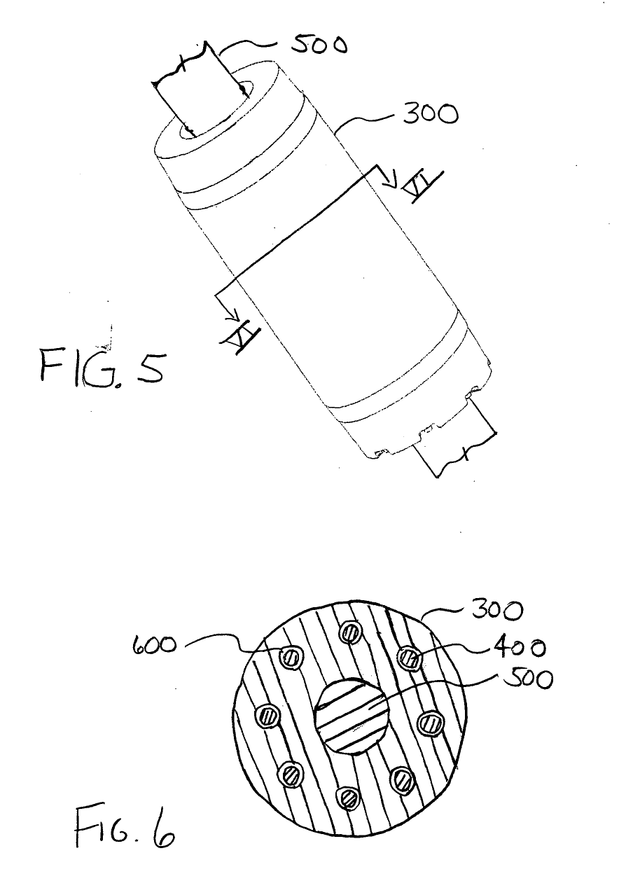

When the rotor 300 is ready for attachment to a shaft, which preferably has an outer diameter greater than the inner diameter of the center bore 104, the rotor is heated to a temperature that is about 600° F. to about 800° F. using any suitable heating technique to expand the center bore 104 of the rotor 300 a sufficient amount to receive the shaft. During the heating of the rotor 300 to expand the center bore 104, the aluminum rotor bars 400 expand faster than the steel rotor core 100. This disproportionate expansion of the materials of the rotor 300 results in the deforming or yielding of either the steel rotor core 100, the aluminum rotor bars 400 or both the steel and aluminum as the rotor 300 is heated resulting in a “breakaway” or breaking of an intimate contact or bonding between the aluminum rotor bars 400 and the steel rotor core 100 which may be formed by the soldering of the aluminum to the steel during the casting or injection molding operation. Once the rotor 300 is properly heated, i.e., the center bore 104 of the rotor 300 has expanded sufficiently to receive the shaft, the shaft is inserted into the center bore 104 of the rotor 300, or alternatively, the rotor 300 is placed or dropped on the shaft via the center bore 104. The rotor 300 can be positioned on the shaft using any suitable manual or automated process. After the rotor 300 is positioned on the shaft, the rotor 300 is permitted to cool. Upon cooling of the rotor 300, the steel rotor core 100 contracts around the shaft to form a tight interference fit or connection between the rotor 300 and the shaft. FIGS. 5 and 6 illustrate the rotor 300 attached to a shaft 500. In addition, as the rotor core 100 is cooling to attach the rotor 300 to the shaft 500, the rotor bars 400 are also cooling in the rotor 300 and a gap 600 is formed between the rotor bars 400 and the rotor core 100 as a result of the deformation of the rotor bars 400 and/or rotor core 100 during the heating shrinking process.

In one embodiment of the present invention, the rotors 300 are heated to the desired temperature using an induction heating technique. The induction heating is accomplished by inducing a current in the rotor cage, which current then is used to heat the rotor 300 from the inside. To induce the current in the rotor 300, the rotor 300 travels through a tube or other suitable device having a plurality of coils disposed within the tube that surround the rotor 300 and generate magnetic fields, which magnetic fields, in turn, induce a current in the rotor cage. The time duration the rotor 300 remains in the tube and the strength or magnitude of the magnetic fields, which magnetic field strength is directly related to the strength or magnitude of the induced current in the rotor, are the primary factors in obtaining the desired rotor temperature. The rotor 300 may be heated in several stages by using several different coils, with each stage having one or more coils positioned in the tube to apply stronger magnetic fields to the rotor 300 as the rotor 300 travels through the tube. The time the rotor 300 spends in the tube can range from 30-90 seconds and is preferably 60 seconds. After the rotor 300 has been heated by the induction heating techniques, the rotors 300 are manually placed or dropped on the shafts 500.

FIG. 6 illustrates a cross-section of the assembled rotor 300 and shaft 500. As can be seen in FIG. 6, the gap 600 has been formed between the rotor bars 400 and the rotor core 100 breaking any intimate contact or bonds previously formed between the rotor bars 400 and the rotor core 100 during the casting or injection molding operation. The gap 600 between the rotor bars 400 and the rotor core 100 is shown greatly exaggerated in FIG. 6 for purposes of illustration and is preferably described as a “grain boundary” between the rotor bars 400 and the rotor core 100. This gap 600 operates as a high impedance barrier that limits the amount of current loss from the rotor bars 400 to the rotor core 100 during operation of the motor. The high impedance gap 600 provides increased motor performance by limiting current losses in the rotor 300.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of attaching a rotor of a compressor motor to a crankshaft of a compressor, the method comprising the steps of:
providing a laminated rotor for a compressor motor having a central bore, the laminated rotor comprising a rotor core and a plurality of rotor bars cast into the rotor core;
providing a crankshaft for a compressor, the crankshaft having an outer diameter greater than an inner diameter of the central bore of the laminated rotor;
heating the laminated rotor to a temperature of about 600-800° F. to expand the central bore of the laminated rotor to a diameter sufficient to receive the crankshaft;
positioning the laminated rotor on the crankshaft; and
cooling the laminated rotor, wherein the cooling of the laminated rotor contracts the rotor core about the crankshaft to connect the laminated rotor to the crankshaft and generates a high impedance gap between the plurality of rotor bars and the rotor core to reduce rotor current losses in a compressor motor.

2. The method of claim 1 wherein the step of heating the laminated rotor comprises the step of heating the laminated rotor to a temperature of about 600-800° F. using an induction heating technique.

3. The method of claim 2 wherein the step of heating the laminated rotor to a temperature of about 600-800° F. using an induction heating technique comprises the step of inducing a current in the plurality of rotor bars with a magnetic field to heat the rotor core and the plurality of rotor bars.

4. The method of claim 3 wherein the step of inducing a current in the plurality of rotor bars with a magnetic field comprises the step of inducing a current in the plurality of rotor bars for about 60 seconds with a magnetic field.

5. The method of claim 1 wherein the step of heating the laminated rotor expands the plurality of rotor bars faster than the rotor core to break any formed bonds between the plurality of rotor bars and the rotor core.

6. The method of claim 1 wherein the step of positioning the laminated rotor on the crankshaft comprises the step of manually dropping the laminated rotor onto the crankshaft.

7. A method of attaching a laminated rotor to a shaft, the method comprising the steps of:
providing a laminated rotor having a central bore, the laminated rotor comprising a rotor core and a rotor cage having a plurality of rotor bars cast into the rotor core;
providing a shaft, the shaft having an outer diameter greater than an inner diameter of the central bore of the laminated rotor;
heating the laminated rotor to a temperature of about 600-800° F. to expand the central bore of the laminated rotor to a diameter sufficient to receive the shaft;
placing the laminated rotor onto the shaft; and
cooling the laminated rotor, wherein the cooling of the laminated rotor contracts the rotor core about the shaft to connect the laminated rotor to the shaft and generates a high impedance gap between the plurality of rotor bars and the rotor core to reduce rotor current losses in a motor incorporating the rotor.

8. The method of claim 7 wherein the step of heating the laminated rotor comprises the step of heating the laminated rotor to a temperature of about 600-800° F. using an induction heating technique.

9. The method of claim 8 wherein the step of heating the laminated rotor to a temperature of about 600-800° F. using an induction heating technique comprises the step of inducing a current in the rotor cage with a magnetic field to heat the rotor core and the plurality of rotor bars.

10. The method of claim 9 wherein the step of inducing a current in the rotor cage with a magnetic field comprises the step of inducing a current in the rotor cage for about 60 seconds with a magnetic field.

11. The method of claim 7 wherein the step of heating the laminated rotor expands the plurality of rotor bars faster than the rotor core to break any formed bonds between the plurality of rotor bars and the rotor core.

12. The method of claim 7 wherein the step of placing the laminated rotor on the shaft comprises the step of manually dropping the laminated rotor onto the shaft.
